(19) United States
(12) Patent Application Publication
(10) Pub. No.: US 2010/0176527 A1
(43) Pub. Date: Jul. 15, 2010

(54) Extruder Arrangement

(75) Inventor: Florian Fischer, Ebersberg (DE)

Correspondence Address: ROBERT W. BECKER & ASSOCIATES, 707 HIGHWAY 333, SUITE B, TIJERAS, NM, 87059-7507, US

(73) Assignee: VMI-AZ Extrusion GmbH, Runding (DE)

(21) Appl. No.: 12/635,541

(22) Filed: Dec. 10, 2009

(30) Foreign Application Priority Data
Dec. 11, 2008 (DE) 10 2008 061 327.4

(51) Int. Cl. B29C 47/36

(52) U.S. Cl. 264/39; 425/113

(57) ABSTRACT

An extruder arrangement comprising a screw extruder for viscous masses, in particular plastic melts or natural or artificial rubber mixtures. The screw extruder comprises an outlet connection that is coupled to a gear pump and further comprises an extruder screw. The outlet connection is arranged adjacent on the side of the extruder screw and a detachable cover or lid is arranged at the front side of the extruder screw.

### BACKGROUND OF THE INVENTION

The invention relates to an extruder arrangement having a screw extruder for viscous masses, in particular plastic melts or natural or synthetic rubber mixtures, the screw extruder being coupled to a gear pump at the outlet connection thereof and being provided with an extruder screw.

An extruder arrangement of this kind, with the aid of which viscous compounds such as rubber mixtures or plastic melts can be extruded, has been known for a long time. DE 31 33 647 C2 or DE 38 33 777 C2 can be mentioned as examples. In the first-mentioned reference a gear pump is arranged at the outlet connection in axial extension of the double screw extruder, the gear wheels of said gear pump engaging with one another and being capable of providing a constant feed rate. A problem existing for decades in this connection is the fact that a transition area exists between the gear pump and the screw extruder that can virtually only be cleaned when the connection between the extruder and the gear pump is disconnected. In this case, the connecting screws between the extruder and the gear pump must be loosened, and either the extruder or the gear pump must be folded away. Both components, that is to say both the extruder and the gear pump, are driven conveyor units, respectively, that each induce separate vibration which not at all simplifies the setting up of a detachable connection.

On the other hand, the extruder/gear pump combination must be run empty each time, when it is shut down or stopped, and basically each time when the material to be extruded is changed, in order to avoid impurities and/or plugging.

Due to those difficulties—despite the undisputed advantages of volumetric conveyors—double screw extruders without an output-sided volumetric conveying device are partially employed.

Further, it has already been proposed to use volumetric conveying devices other than gear pumps. The solution or approach known from DE 10 2005 050 619 A1 provides an example.

Moreover, it has also already been proposed to use a planetary gear pump as volumetric conveying device. In this connection, reference is made to DE 101 54 860 A1. In this solution, too, it is necessary to clean the transition area in the case of the abovementioned application cases and for this purpose to separate the pump from the extruder.

Contrary to that, the invention is based on the object of providing an extruder arrangement of the aforementioned general type as well as a corresponding method of operating an extruder arrangement having a screw extruder and a gear pump that convey a viscous mass that are optimized with regard to the manageability, without sacrificing the advantages of volumetric conveyance.

This object is solved by an extruder arrangement comprising: a screw extruder for viscous masses, wherein the screw extruder is provided with an extruder screw and an outlet connection disposed laterally adjacent to the extruder screw; and a gear pump disposed at the outlet connection for receiving viscous mass therefrom. The object is also solved by a method of operating an extruder arrangement and including the steps of: providing a gear pump with two gear wheels having axes that either extend parallel to an axis of an extruder screw of the screw extruder or, where the screw extruder is a double screw extruder, parallel to a plane passing through axes of the screw extruders; providing a cover adapted to be mounted on an end face of the screw extruder; and cleaning a transition area between the screw extruder and the gear pump by removing the cover and emptying the extruder arrangement by removing mass, through the opening released by the removal of the cover, by rotating the extruder screw or extruder screws of the screw extruder.

According to the invention, it is particularly favorable that the gear pump is arranged laterally adjacent to and substantially completely radially outside of all extruder screws of the screw extruder that substantially extends parallel to the arrangement of the gear pump. The gear pump preferably comprises two gear wheels meshing with one another and having the same size, and immediately borders on the extruder screw of the screw extruder. The transition area that exists between the pump and the extruder in this arrangement, is substantially triangular and notedly small.

According to the invention, it is particularly preferred that better self-cleaning is feasible due to the implementation of the notedly small and substantially triangular transition area. The system existing there and in this respect having a quite small mass, is quasi dragged by the gear wheels of the gear pump at a corresponding viscosity such that the elsewise usual cleaning steps necessary in the case of an axial arrangement of the extruder and the pump can at least partially be dispensed with.

According to the invention it is also particularly favorable that the transition area can be embodied notedly small. The result is low material losses, especially in the case of a triangle arrangement of extruder screw and gear pump.

According to the invention it is also favorable that a simple filling of the gear pump is possible as well. For example, the extruder can be operated under decreased temperature and under decreased pressure for filling the gear pump until the small transition area is filled, in order to ensure a gentle and undisturbed starting-up of the extruder/gear pump combination.

According to the invention it is essential that the outlet connection of the screw extruder extends laterally to, that is to say in radial direction of, the extruder screws or the extruder screw, and immediately adjacent to the gear wheels of the gear pump that extend parallel to the plane of the outlet connection.

For realizing a preferred cover or lid according to the invention that is flange-mounted to the front side of the screw extruder, the cleaning of the transition area can be effected in a simple manner, and the transition area can be made accessible from the front side. By opening the cover or lid, the transition area is exposed in axially parallel direction. If the extruder is now operated slowly, the remaining material residing there is pushed out at the front through the cover or lid opening. This is also successfully effected with helically geared gear wheels of the gear pump with regard to the low friction resistance in the axial direction along the axial direction of the tooth flanks of the gear wheels of the gear pump.

According to the invention it is particularly favorable that the cover or lid can be used as a start-up valve as well. For this purpose the cover or lid is opened when the extruder arrangement is started up. The extruder conveys and the conveyed compound is discharged to the outside. As soon as the process reaches a stable condition, the cover or lid is closed such that conveying immediately starts with a stable process. In this respect, the inventive cover or lid is not limited to the embodiment illustrated. For example, a stud comprising a transverse opening can be used as a cover or lid as well, said stud being turned if the start-up valve or the cover or lid, respectively, is closed and has a position that enables conveying or discharging the compound to the outside, when the cover or lid or the start-up valve, respectively, is to be open.

Any other suitable closing element can be employed as well, for example a slide or any other actuatable element that enables two positions, that is to say a release position and a closing position.

If a double screw extruder arrangement is selected, it can be inventively designed in a similar manner. By nature—in particular with the gear wheels and the extruder screws having the same external diameters—the transition area is substantially rhombus-shaped and enlarged. In order to compensate for this enlargement, a small offset of the extruder screws relative to the gear wheels is possible. As a result, the transition area is quasi flattened and reduced with regard to its volume. Alternatively, it is also possible to use an insert body that separately from the cover or lid or flange-mounted thereto, extends into the transition area in a flow-enhancing manner and exclusively serves to reduce the remaining material residing there. After having emptied the extruder, the insert body is quickly removed after having opened the cover or lid, and the extruder is slowly started up in order to clean the transition area.

According to the invention it is further favorable that no mechanical separation between the extruder and the gear pump is necessary. Thus, the design is considerably simplified and it is further ensured that the gear pump and the extruder quasi automatically always have the same temperature because there exists a metallic connection between the extruder housing and the gear pump housing.

Moreover, with the aid of the inventive cover or lid, the maintenance and service of the extruder screws, for example also the inspection of a true or smooth running, is simplified, since this is detectable by axial visual inspection with simple means during idle running of the extruder with the lid or cover being opened while the extruder screws are running smoothly.

According to the invention it is particularly favorable that a necessary mounting or support of the extruder screws at the front ends thereof is not at all more complex than with usual extruder screws having the outlet connection on the front side thereof. A lateral support of the extruder screws is easily possible.

In an advantageous embodiment of the invention it is provided that the extruder screws or the extruder screw and the gear wheels of the gear pump are densely packed relative to one another. Basically, a transmission or gear wheel engagement between the extruder screw and the gear pump would even be representable, but only in the case that a variable setting of the rotational speed ratio thereof relative to one another is not required.

The inventive cover or lid can be attached in a mechanically or hydraulically actuatable manner, preferably it is mounted on the extruder housing. For example, suitable studs, if applicable in combination with a hinge on one side, can be used in this connection. Alternatively, the cover or lid can be opened and closed hydraulically or also pneumatically. Although for inspection purposes it is particularly favorable that the entire front side of the screw arrangement of the extruder including the transition area through which the outlet connection of the extruder extends; is covered by the cover or lid, it is also possible in a modified embodiment to merely cover the transition area with the aid of the cover or lid and to form the remaining front side and the remaining extruder housing in one piece.

Moreover, according to the invention it is favorable that the inventive solution can be employed both for double screw extruders rotating in the same direction and for conical double screw extruders. In the case of double screw extruders, the axes of both extruder screws do not extend parallel to one another but do converge towards one another in a transverse manner. According to the invention, the plane spanned by the axes thereof is slightly inclined towards the plane of the outlet connection and at the same time parallel to the plane of the axes of the gear wheels of the gear pump.

According to the invention, the outlet connection of the extruder is formed on the side of the front area of the extruder screw or the extruder screws. The material conveyed by the extruder screws thus exits or is discharged on the side thereof, while the front side of the extruder screws is closed.

### BRIEF DESCRIPTION OF THE DRAWINGS

Further advantages, details and features of the invention emerge from the following description of several exemplary embodiments with reference to the drawings, in which:

FIG. 1 shows a schematic view of a detail of a first embodiment of the extruder arrangement according to the invention;

FIG. 2 shows a sectional view through the embodiment according to FIG. 1, also in schematic representation;

FIG. 3 shows a sectional view through a modified embodiment in the representation according to FIG. 2;

FIG. 4 shows a side view of an inventive extruder arrangement in a further embodiment;

FIG. 5 shows a sectional view along the line A-A according to FIG. 4;

FIG. 6 shows a sectional view along the line B-B from FIG. 4;

FIG. 7 shows a schematic view of a detail of a third embodiment of an extruder arrangement according to the invention;

FIG. 8 shows a schematic view of a fourth embodiment of an extruder arrangement according to the invention; and

FIG. 9 shows a schematic view of a fifth embodiment of an extruder arrangement according to the invention.

### DESCRIPTION OF SPECIFIC EMBODIMENTS

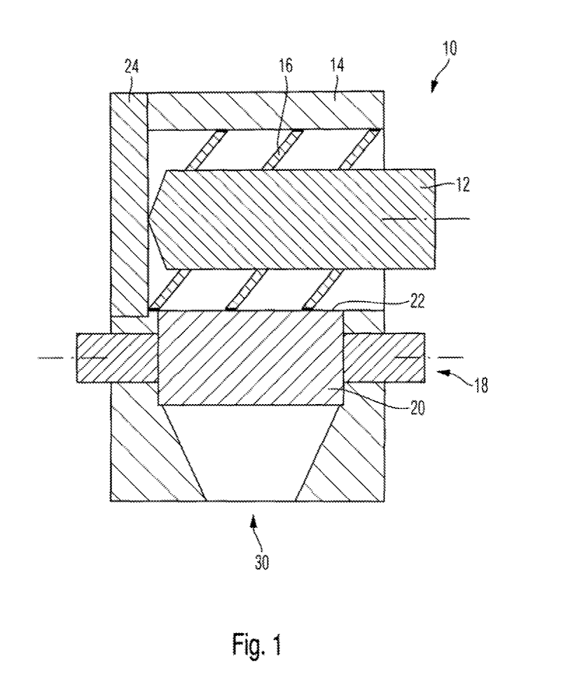

The embodiment of the extruder arrangement 10 illustrated in FIG. 1 comprises an extruder screw 12 that is supported in a housing 14 in a manner known per se. FIG. 1 represents the front part, that is to say the output-sided part of the extruder screw 12 and the housing 14, and FIG. 1 further shows the spiral or worm coil 16 of the extruder screw.

Radially outside the extruder screw spiral coil 16, but immediately adjacent thereto, a gear pump 18 is provided according to the invention, said gear pump comprising gear wheels 20, one of which is represented schematically. The gear wheel 20 extends parallel to the extruder screw 12. In this respect, the outlet connection 22 of the extruder arrangement is provided to the side or laterally of the extruder screws 16.

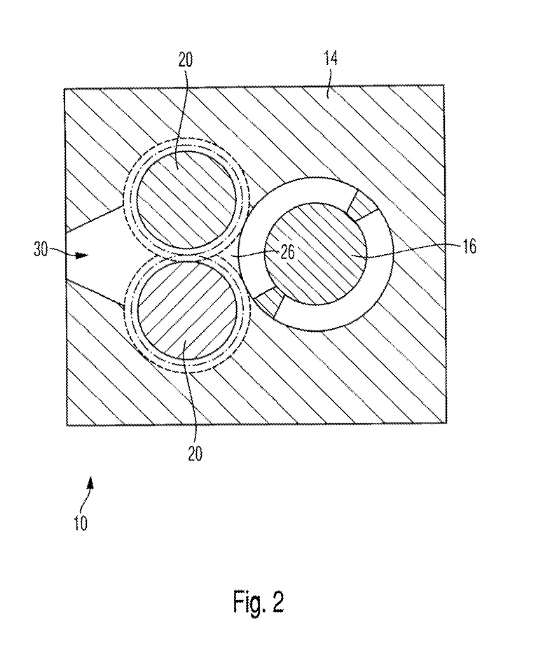

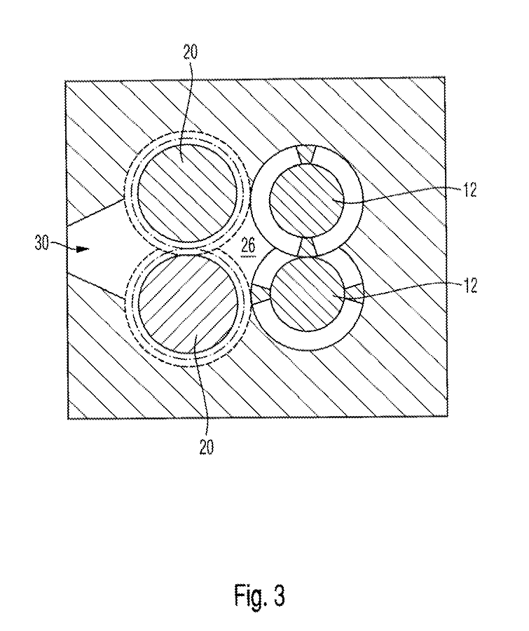

According to the invention, a cover or lid 24 is arranged on the face side of the extruder screws 12. The cover or lid 24 is detachably mounted on the housing 14. The cover or lid protrudes beyond the extruder screws 16 to a small extent, and thus also protrudes the outlet connection 22, and in this respect covers the transition area 26 that is apparent in FIG. 2, at least for the most part. In the case of a larger transition area, such as is shown in FIG. 3, the cover or lid 24 is preferably still more enlarged in the direction of the gear pump relative to the transition area.

The material conveyed with the aid of the extruder screw 12 exits the area of the extruder screw 12 on the side of the front end thereof and leaves the extruder screw via the outlet connection 22. The material then reaches the area of the volumetric conveyor that is implemented in the form of a gear pump 18. The gear pump 18 that for example comprises two gear wheels, conveys the viscous mass to an outlet nozzle 30 to which an extruder head (not shown) may be connected for example.

For cleaning the transition area, that is to say approximately in the area of the outlet connection 22 in FIG. 1, the cover or lid 24 is detachable. Then, when the cover or lid is removed, the extruder is operated at low rotational speed and remaining material from the transition area is axially conveyed out of the open orifice that normally is closed with the aid of the cover or lid 24. If needed, a suitable tool can be used to assist the conveyance, although this is regularly not necessary as the teeth of the gear wheels 20 of the gear pump 18 also typically extend in the axial direction or at least—in the case of helical gearing—substantially extend in the axial direction.

In the same manner, the gear pump can also be filled under low pressure—and thus under low temperature. Further, a maintenance of the extruder screws 12 can be comparatively easily conducted due to the opening of the cover or lid 24.

FIG. 2 illustrates, in which manner an extruder screw 12/16 is arranged in its relative position to the gear wheels 20 of the gear pump 18. The extruder screw 12 is arranged in close vicinity to the double arrangement of gear wheels 20. As indicated in the drawing, a remaining transition area 26 extends between the double arrangement of gear wheels 20, said transition area comprising concave lateral surfaces corresponding to the radii of the adjacent parts. The transition area must be emptied as well when running the extruder empty, and according to the invention, friction of the extruder screws acting in the axial direction can be employed for this purpose and a detachable mounting of the housings for the gear pump and the extruder necessary up to now is thus dispensable.

To that effect, the housing 14 as well is represented in one piece in FIG. 2.

FIG. 3 illustrates a modified embodiment of the extruder arrangement according to the invention. The extruder arrangement provides a double screw extruder with accordingly two extruder screws 12. Said extruder screws extend on the side of gear wheels 20 and between these four elements substantially having a circular cross-section, a transition area 26 extends that in contrast to the embodiment according to FIG. 2 is considerably larger in size. This transition area 26 as well can be run empty according to the invention, as the cover or lid according to FIG. 1 protrudes beyond the transition area 26 in the embodiment illustrated.

In a modified embodiment, the extruder screws each have a conical shape according to FIG. 3 and thus have a larger inlet diameter than outlet diameter. This solution enables a favorable fluidic adjustment to large filling openings. Both the realization of conveying screws rotating in the same direction and conveying screws rotating in the opposite direction is possible. On the output side, that is to say approximately in the area shown in FIG. 3, extruder screws of this kind have a considerably smaller diameter that can also be smaller than the diameter of the gear wheels 20 of the gear pump 18.

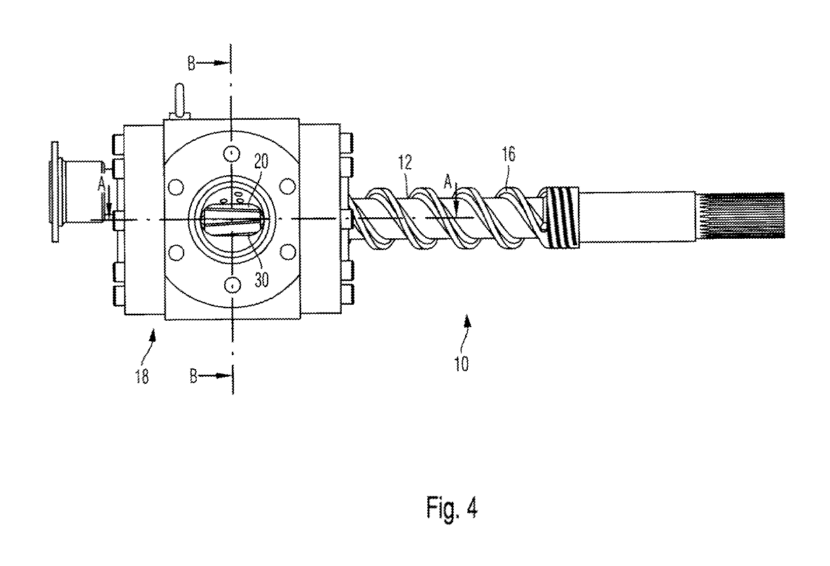

FIG. 4 illustrates a modified embodiment of an inventive extruder arrangement 10. As shown in FIG. 4, the extruder screw 12 with its spiral coils 16 extends towards a gear pump 18.

FIG. 4 as well shows that gear wheels 20 of the gear pump 18 mesh with one another and further illustrates the design of the outlet nozzle 30.

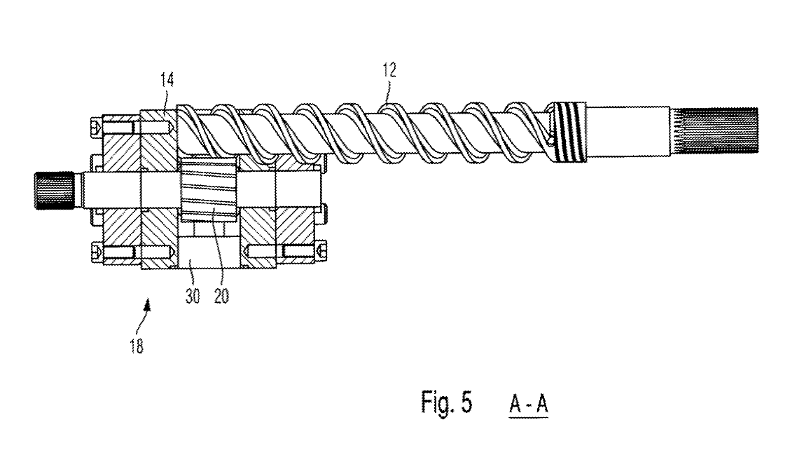

In contrast to that, FIG. 5 illustrates the manner in which the gear pump 18 may be mounted. The transition area extends between/above the gear wheels 20 such that the extruder screw 12 shown in FIG. 5 overlaps the gear wheel 20 in the drawing according to FIG. 5. The transition area and the cover or lid (not shown in FIG. 5) that makes the transition area freely accessible from the outside in the case of being removed, are provided behind the drawing plane. In this embodiment, the extruder screw 12 comprises a blunt end and the front face thereof is covered by a part of the housing 14, in the embodiment illustrated as part of the gear pump.

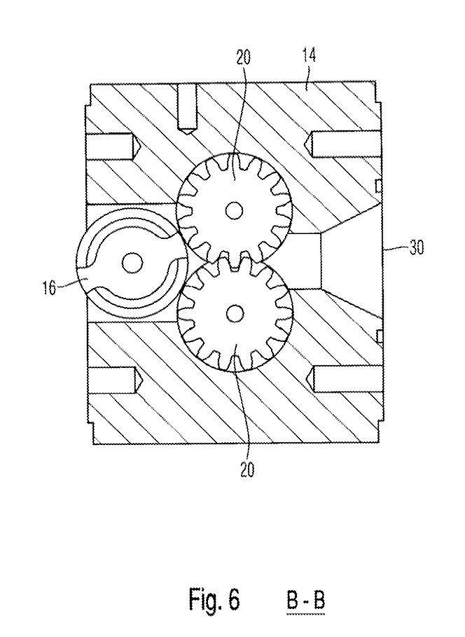

As shown in FIG. 6, the extruder screw 12 can be received in some kind of chamber of the housing 14, whereby it is to be understood that a contact or a direct abutment between the extruder screw and the gear wheels 20 of the gear pump is not desired.

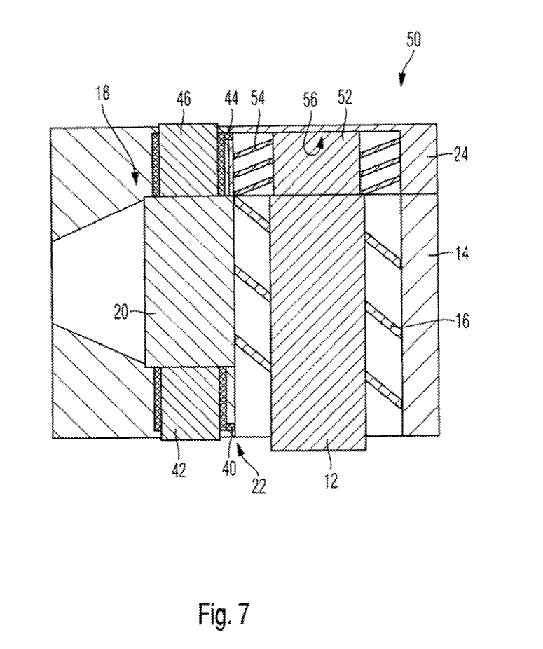

FIG. 7 represents a further embodiment of an extruder arrangement according to the invention. In this figure as well as in the further figures, the same reference numerals refer to the same or corresponding components.

The embodiment of FIG. 7 is characterized by having an explicit hydrodynamic mounting. For this purpose, a portion of the conveyed volume is branched off the material flow of the extruder screw 16 in a channel 40, in fact before the outlet connection 22, that is to say upstream of this position. The short channel implemented there results in a cylinder gap that surrounds a bearing pin 42 of a gear wheel 20.

A corresponding channel 44 is provided further downstream from the outlet connection 22 and leads to a cylinder gap that surrounds the opposite bearing pin 46 of the same gear wheel 20. In this manner, the gear wheel 20 experiences a hydrodynamic mounting or support with the aid of the leakage volume flow branched off in this way.

An additional preferred embodiment provides for the implementation of a return conveying device 50 on the front side of the extruder screw 12. With the aid of the return conveying device 50 it is to be avoided that residual material remains at the front side of the conveying screw 16, even in the case that the cover or lid is not provided or is only partially provided. Moreover, the feed or supply efficiency for the gear pump 18 is to be improved.

In the illustrated embodiment according to FIG. 7, the extruder screw 12 is elongated with the aid of an extruder screw pin 52. The extruder screw pin 52 supports or carries a counter helix or spiral coil 54 that rotates in the opposite direction compared to the extruder screw spiral coil 16. Due to the fact that the extruder screw pin 52 is formed in one piece or is formed as a separate component together with the extruder screw 12, a conveying effect contrary to that of the extruder screw spiral coil 16 arises, that is to say a return conveyance that enhances the supply of material to the transition area and therefore to the gear pump 18.

In the exemplary embodiment illustrated, the counter spiral coil 54 is formed together with the extruder screw pin 52 in a respective recess 56 in the cover or lid 24. It is to be understood that instead of this arrangement it is also possible to realize the arrangement in a fixed front side of the housing 14.

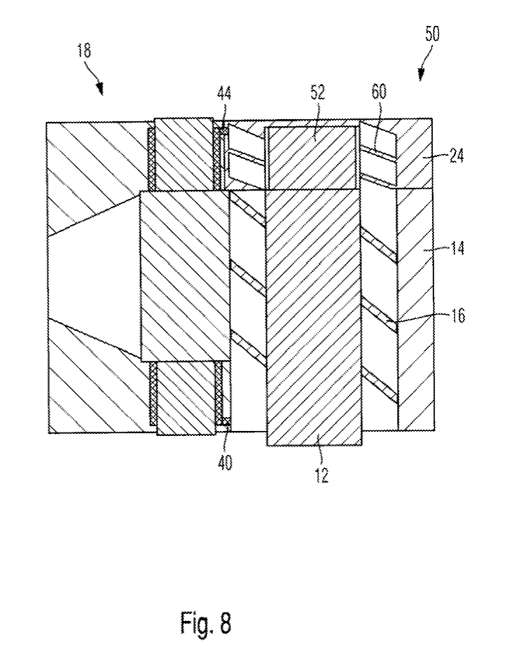

The embodiment according to FIG. 8 is also characterized by a hydrodynamic mounting or support of the gear wheels 20 and by a return conveyance. In this embodiment, a return conveying arrangement or channel 60 is formed in the front surface of the housing 14 or in the cover or lid 24. This return conveying channel is stationary, that is to say it is fixed to the housing or to the cover or lid. In a manner known per se from transfer extruders, the return conveying channel extends in the same direction as the extruder screw spiral coil 16, and the extruder screw pin 52 extends in the form of a cylinder that has a diameter that is decreased relative to the core of the extruder screw 12 into the cover or lid 24.

Also in this case it is possible to provide for a floating support or mounting of the gear pump 18 with the aid of the channels 40 and 44, whereby the channel 44 is arranged on the end side of the return conveying device 50.

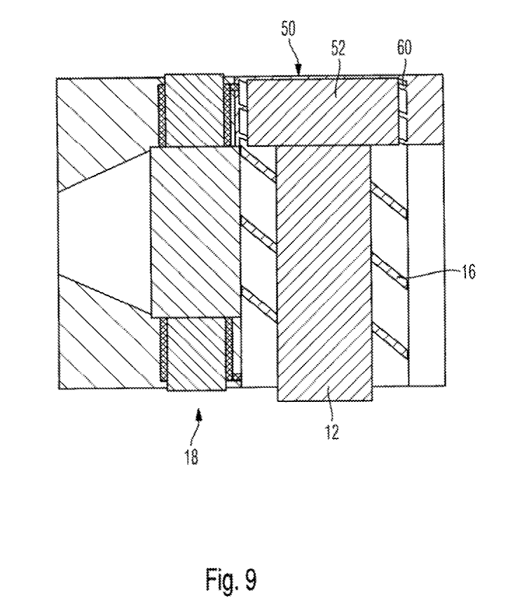

FIG. 9 compared to FIG. 8 illustrates a slightly modified fifth embodiment of the inventive embodiment of the extruder arrangement according to the invention. In this solution, the extruder screw pin 52 is enlarged, that is to say compared to the embodiment according to FIG. 8 its diameter is larger than the core diameter of the extruder screw 12. Also in this case, a return conveying channel 60 extends along an extension of the screw spiral coil 16 of the extruder screw 12 for forming the return conveying device 50.

With the aid of this design it is possible to use the extruder screw pin 52 virtually as some kind of hydrodynamic mounting or support as well and at the same time to ensure the return transport of the viscous compound.

The specification incorporates by reference the disclosure of German priority document DE 10 2008 061 327.4 filed Dec. 11, 2008.

The present invention is, of course, in no way restricted to the specific disclosure of the specification and drawings, but also encompasses any modifications within the scope of the appended claims.

I claim:

1. An extruder arrangement, comprising:
a screw extruder for viscous masses, wherein said screw extruder is provided with and extruder screw and an outlet connection disposed laterally adjacent to said extruder screw; and
a gear pump disposed at said outlet connection for receiving viscous mass therefrom.

2. An extruder arrangement according to claim 1, wherein a closure element, in particular a removable cover, is disposed at an end face of said extruder screw.

3. An extruder arrangement according to claim 1, wherein said gear pump is provided with gear wheels that mesh with one another, further wherein axes of said gear wheels extend essentially parallel, in particular parallel, to the axis of said extruder screw, and wherein said gear pump is in particular composed of two gear wheels that mesh with one another.

4. An extruder arrangement according to claim 1, wherein said gear pump is provided with two gear wheels that mesh with one another and have essentially the same diameter, and wherein said extruder screw is disposed such that it is arranged substantially adjacent to said two gear wheels as viewed in a radial direction.

5. An extruder arrangement according to claim 4, wherein said gear wheels and said extruder screw have essentially the same diameter.

6. An extruder arrangement according to claim 4, wherein axes of said gear wheels of said gear pump and an axis or axes of said extruder screw or extruder screws are offset relative to one another.

7. An extruder arrangement according to claim 4, wherein said extruder is embodied as a double screw extruder and is mounted laterally closely adjacent to said gear wheels of said gear pump, further wherein the two axes of the screws of said double screw extruder define an extruder plane, further wherein the axes of said gear wheels of said gear pump define a pump axis plane, and wherein said extruder plane and said pump axis plane extend parallel to one another.

8. An extruder arrangement according to claim 7, wherein said extruder screws are tapered such that diameters thereof decrease in a downstream direction, and wherein the axes of said extruder screws converge.

9. An extruder arrangement according to claim 7, wherein said outlet connection extends in a transition area disposed between said screw extruder and said gear pump, and wherein a volume of said transition area is reduced relative to a rhombus or triangle, either due to an offset of said extruder screw or extruder screws relative to said gear wheels of said gear pump, or due to an insert body that at least partially fills said transition area.

10. An extruder arrangement according to claim 4, wherein said gear wheels of said gear pump extend essentially parallel to said extruder screw and essentially over a forward-most, i.e. downstream, fourth of said extruder screw.

11. An extruder arrangement according to claim 1, wherein said screw extruder has an extruder housing, further wherein said gear pump has a pump housing, and wherein said housings are interconnected in a nonscrew-connected manner, in particular being monolithically embodied, and are thermally equally connected with one another by being integrally formed.

12. An extruder arrangement according to claim 1, wherein channels branch off laterally of a forward region of said extruder screw or extruder screws, and wherein said channels provide hydrodynamic mounting for gear wheel shafts of said gear pump.

13. An extruder arrangement according to claim 1, which further includes a return conveying device on an end face of the front side of the extruder screws.

14. An extruder arrangement according to claim 1, wherein a cover is secured to a housing of said screw extruder and covers, in particular entirely covers, an end face of said screw extruder.

15. An extruder arrangement according to claim 14, wherein said cover is hydraulically and/or pneumatically connected to at least one of said screw extruder housing and/or said gear pump.

16. An extruder arrangement according to claim 14, wherein removal of said cover is adapted to release a transition area disposed between said screw extruder and said gear pump.

17. An extruder arrangement according to claim 14, wherein said cover is adapted to replace a start-up valve of the extruder/gear pump combination, that can be opened for starting said extruder arrangement and closed when an extrusion process is in a stable condition.

18. A method of operating an extruder arrangement having a screw extruder and a gear pump that convey a viscous mass, including the steps of:
providing said gear pump with two gear wheels having axes that either extend parallel to an axis of an extruder screw of said screw extruder, or, where said screw extruder is a double screw extruder, parallel to a plane passing through axes of the screw extruders;
providing a cover adapted to be mounted on an end face of said screw extruder; and
cleaning a transition area disposed between said screw extruder and said gear pump by removing said cover and emptying said extruder arrangement by removing mass, through the opening released by the removal of said cover, by rotating the extruder screw or extruder screws of said screw extruder.

19. A method according to claim 18, which includes the further step of filling said gear pump laterally from said screw extruder at low pressure and low temperature.
